(19) United States
(12) Patent Application Publication
(10) Pub. No.: US 2011/0155713 A1
(43) Pub. Date: Jun. 30, 2011

(54) Carbon nanotube defrost windows

(75) Inventors: Yu-Quan Wang, Beijing (CN); Liang Liu, Beijing (CN)

(73) Assignee: Beijing Funate Innovation Technology Co., LTD., Beijing City (CN)

(21) Appl. No.: 12/806,499

(22) Filed: Aug. 13, 2010

(30) Foreign Application Priority Data
Dec. 29, 2009 (CN) 200910265337.4

(51) Int. Cl. B60L 1/02

(52) U.S. Cl. 219/203

(57) ABSTRACT

A defrost window includes a transparent substrate, a carbon nanotube film, a first electrode, a second electrode and a protective layer. The transparent substrate has a top surface. The carbon nanotube film is disposed on the top surface of the transparent substrate. The first electrode and the second electrode electrically connect to the carbon nanotube film and space from each other. The protective layer covers the carbon nanotube film.

This application claims all benefits accruing under 35 U.S.C. §119 from China Patent Application No. 200910265337.4, filed on 2009 Dec. 29, in the China Intellectual Property Office, incorporated herein by reference.

### BACKGROUND

1. Technical Field

The present disclosure relates to defrosting windows and vehicles using the same, particularly, to a defrosting window based on carbon nanotubes and a vehicle using the same.

2. Description of Related Art

Good visibility through the windows of a vehicle is critical for safe driving. In the morning of winter days, the windows of the vehicles often have a thin layer of frost. The frost on the windows could badly affect the driver's visibility. Therefore, it is necessary to scrape the frost off the windows of the vehicle before driving.

To get rid of the frost on the windows of the vehicles, a conductive paste of metal powder is coated on the windows to form a conductive layer. A voltage is applied to the conductive layer to generates heat and melt the frost. However, the conductive layer is not a whole structure formed on the surface of the vehicle windows. Thus, the conductive layer can shed from the vehicle windows, which will badly affect the defrosting process.

What is needed, therefore, is a defrost window with good defrosting effect, and a vehicle using the same.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of an embodiment of a defrost window.

FIG. 2 is a cross-sectional view taken along a line II-II of the defrost window shown in FIG. 1.

FIG. 3 is a Scanning Electron Microscope (SEM) image of a carbon nanotube film used in the defrost window of FIG. 1.

FIG. 4 is a schematic view of a carbon nanotube segment in the carbon nanotube film of FIG. 3.

FIG. 5 is schematic view of an embodiment of a defrost window in operation.

FIG. 6 is a schematic view of another embodiment of a defrost window.

FIG. 7 is a schematic view of one embodiment of a vehicle with the defrost window of FIG. 1.

FIG. 8 is a schematic view of one embodiment of a defrost system with a defrost window used in a vehicle.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

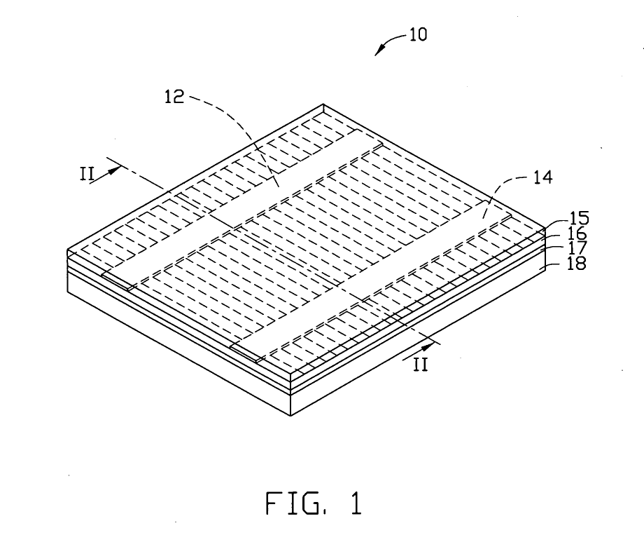

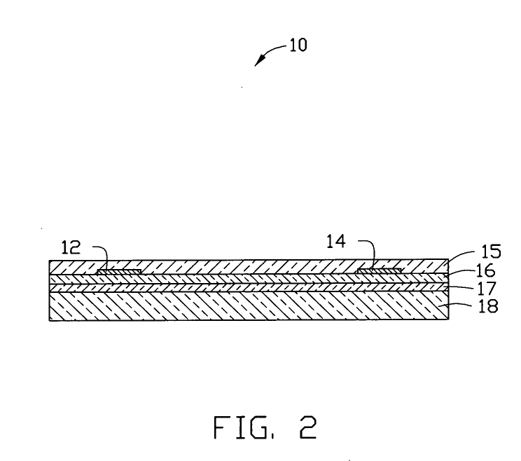

Referring to FIG. 1 and FIG. 2, one embodiment of a defrost window 10 includes a transparent substrate 18, an adhesive layer 17, a carbon nanotube film 16, a first electrode 12, a second electrode 14, and a protective layer 15. The adhesive layer 17 can be located on a top surface of the transparent substrate 18 and a bottom surface of the carbon nanotube film 16, to adhere the carbon nanotube film 16 to the transparent substrate 18. The first electrode 12 and the second electrode 14 are electrically connected to the carbon nanotube film 16 and spaced from each other a certain distance. The protective layer 15 is disposed on a top surface of the carbon nanotube film 16 and covers the carbon nanotube film 16, the first electrode 12, and the second electrode 14.

The transparent substrate 18 can have a curved structure or a planar structure and functions as a supporter with suitable transparency. The transparent substrate 18 may be made of a rigid material, such as glass, silicon, diamond, or plastic. The shape and size of the transparent substrate 18 is not limited, and can be determined according to need. For example, the transparent substrate 18 may be square, round, or triangular. In one embodiment, the transparent substrate 18 is a square sheet about 1 centimeter thick, and made of glass.

The adhesive layer 17 can be formed on the top surface of the transparent substrate 18 by a screen-printing method. The adhesive layer 17 may be a thermoplastic adhesive or ultraviolet rays adhesive, such as polyvinyl polychloride (PVC) or polymethyl methacrylate acrylic (PMMA). A thickness of the adhesive layer 17 can be selected according to need, so long as the adhesive layer 17 can fix the carbon nanotube film 16 on the transparent substrate 18. The thickness of the adhesive layer 17 is in a range from about 1 nanometer to about 500 μm. In one embodiment, the thickness of the adhesive layer 17 is in a range from about 1 μm to about 2 μm. In one embodiment, the adhesive layer 17 is made of PMMA, and the thickness of the adhesive layer 17 is about 1.5 μm.

The carbon nanotube film 16 can be a free-standing structure, meaning that the carbon nanotube film 16 can be supported by itself without a substrate for support. For example, if a point of the carbon nanotube film 16 is held, the entire carbon nanotube film 16 can be supported from that point without damage. The carbon nanotube film 16 includes a plurality of carbon nanotubes combined end to end by Van der Waals attractive force therebetween, and oriented along a same direction. The carbon nanotube film 16 can be a substantially pure structure consisting of the carbon nanotubes with few impurities and is transparent. The carbon nanotube film 16 can be fixed on the top surface of the transparent substrate 18 firmly because the carbon nanotubes of the carbon nanotube film 16 combined end to end by Van der Waals attractive force have good adhesion. The carbon nanotube film 16 is a whole structure, which means that the carbon nanotubes of the carbon nanotube film 16 are connected to each other, and form a free-standing structure, thus it is not easy to shed from the transparent substrate 18.

In one embodiment, the entire carbon nanotube film 16 is attached on the top surface of the transparent substrate 18 via the adhesive layer 17. In other embodiments, the carbon nanotube film 16 includes a number of micropores, and the adhesive layer 17 is permeated in the micropores of the carbon nanotube film 16.

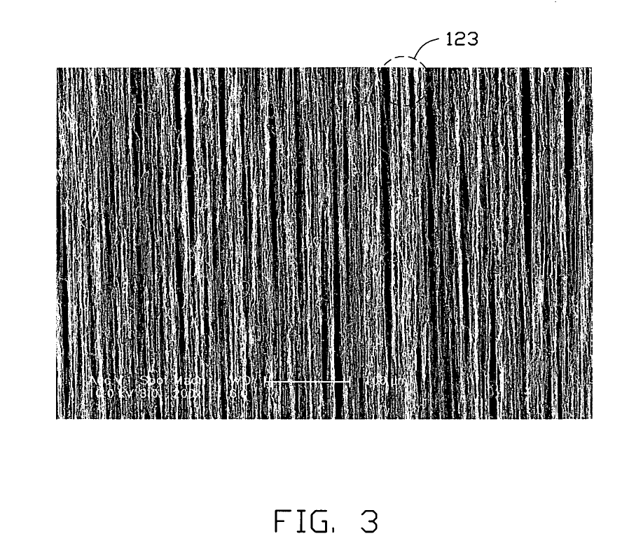

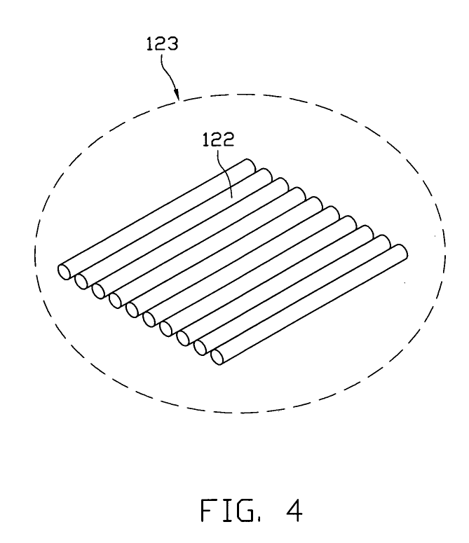

Referring to FIG. 3 and FIG. 4, the carbon nanotube film 16 includes a plurality of successively oriented carbon nanotube segments 123 joined end-to-end by Van der Waals attractive force therebetween. Each carbon nanotube segment 123 includes a plurality of carbon nanotubes 122 substantially parallel to each other, and combined by Van der Waals attractive force therebetween.

The heat capacity per unit area of the carbon nanotube film 16 can be less than about 2×10⁻⁴ J/m²*K. Typically, the heat capacity per unit area of the carbon nanotube film 16 is less than or equal to about 1.7×10⁻⁶ J/m²*K. Because the heat capacity of the carbon nanotube film 16 is very low, and the temperature of the carbon nanotube film 16 can rise and fall quickly, the carbon nanotube film 16 has a high heating efficiency and accuracy. Furthermore, because the carbon nanotube film 16 can be substantially pure, the carbon nanotubes do not oxidize easily and the life of the carbon nanotube film 16 will be relatively long. The carbon nanotubes also have a low density, for example, about 1.35 g/cm³, so the carbon nanotube film 16 is light. Because the heat capacity of the carbon nanotube film 16 is very low, the carbon nanotube film 16 has a high response heating speed. The carbon nanotubes have a large specific surface area. Accordingly, the carbon nanotube film 16 with a plurality of carbon nanotubes has, large specific surface area. If the specific surface of the carbon nanotube structure is large enough, the carbon nanotube film 16 is adhesive and can be directly applied to the top surface of the transparent substrate 18 without the adhesive layer 17.

The first electrode 12 and the second electrode 14 should have good conductive properties. The first electrode 12 and the second electrode 14 can be conductive films, metal sheets, or metal lines, and can be made of pure metals, metal alloys, indium tin oxide (ITO), antimony tin oxide (ATO), silver paste, conductive polymer, and metallic carbon nanotubes, and combinations thereof. The pure metals and metal alloys can be aluminum, copper, tungsten, molybdenum, gold, cesium, palladium, or combinations thereof. The shape of the first electrode 12 or the second electrode 14 is not limited and can be for example, lamellar, rod, wire, or block shaped. In the embodiment shown in FIG. 1, the first electrode 12 and the second electrode 14 are made of ITO, and are both lamellar and substantially parallel with each other. The carbon nanotubes in the carbon nanotube film 16 are aligned along a direction substantially perpendicular to the first electrode 12 and the second electrode 14.

The first electrode 12 and the second electrode 14 can be disposed on a same surface or opposite surfaces of the carbon nanotube film 16. It is imperative that the first electrode 12 can be separated from the second electrode 14 to prevent a short circuit of the electrodes. The first electrode 12 and the second electrode 14 can be electrically attached to the carbon nanotube film 16 by a conductive adhesive (not shown), such as silver adhesive. In some embodiments, the first electrode 12 and the second electrode 14 can be adhered directly to the carbon nanotube film 16 because some carbon nanotube films 16 have a large specific surface area and are adhesive in nature.

The protective layer 15 covers and protects the carbon nanotube film 16, the first electrode 12, and the second electrode 14. The protective layer 15 is made of a transparent polymer. The protective layer 15 can be made of polycarbonate (PC), PMMA, polyethylene terephthalate (PET), polyether polysulfones (PES), PVC, benzocyclobutenes (BCB), polyesters, acrylic resins, or epoxy resin. The thickness of the protective layer 15 is not limited, and can be selected according to the need. In one embodiment, the transparent substrate 18 is made of epoxy resin with a thickness about 200 micrometers.

It is to be understood that the defrost window 10 can include a number of carbon nanotube films 16 stacked one on top of another on the top surface of the transparent substrate 18. Additionally, if the carbon nanotubes in the carbon nanotube film 16 are aligned along one of the preferred orientations (e.g., the drawn carbon nanotube film). An angle can exist between the orientations of the carbon nanotubes in adjacent films, whether stacked or adjacent. Adjacent carbon nanotube films 16 can be combined by the Van der Waals attractive force therebetween. The carbon nanotubes of at least one carbon nanotube film 16 are oriented along a direction from the first electrode 12 to the second electrode 14.

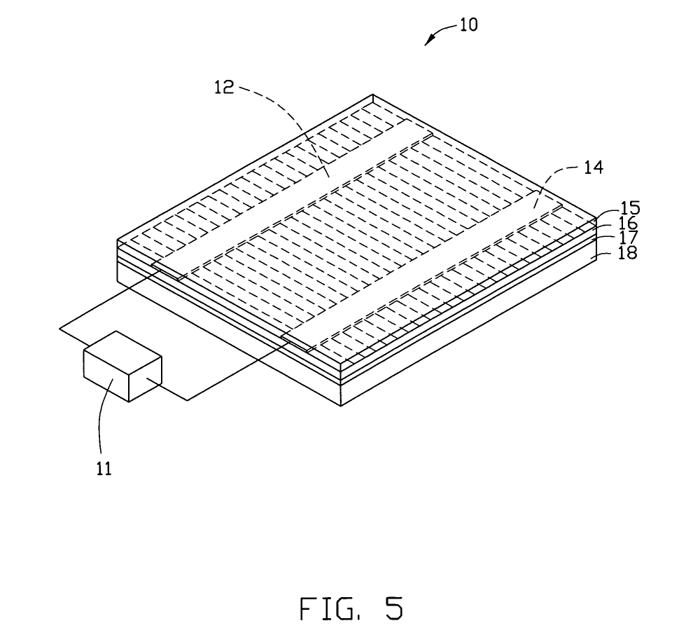

Referring to FIG. 5, in use, when a voltage of an electrical source 11 is applied to the carbon nanotube film 16 via the first electrode 12 and the second electrode 14, the carbon nanotube film 16 radiates heat at a certain wavelength. Therefore, the heat is transmitted to the transparent substrate 18. The frost on the defrost windows 10 melts because of the heat through the transparent substrate 18.

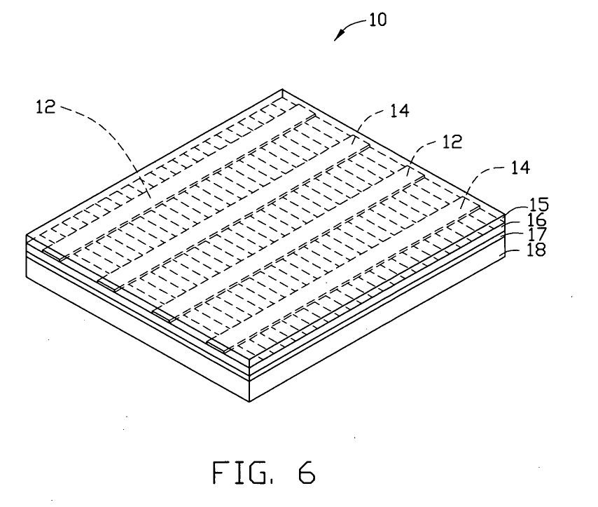

Referring to FIG. 6, in one embodiment, the defrost window 10 can include a plurality of alternatively arranged first and second electrodes 12 and 14. The first electrodes 12 and the second electrodes 14 can be arranged in a staggered manner, for example, side by side as shown in FIG. 6. All of the first electrodes 12 are electrically connected together, and all of the second electrodes 14 are electrically connected together. A voltage is applied on the carbon nanotube film 16 from the first electrodes 12 to the second electrodes 14.

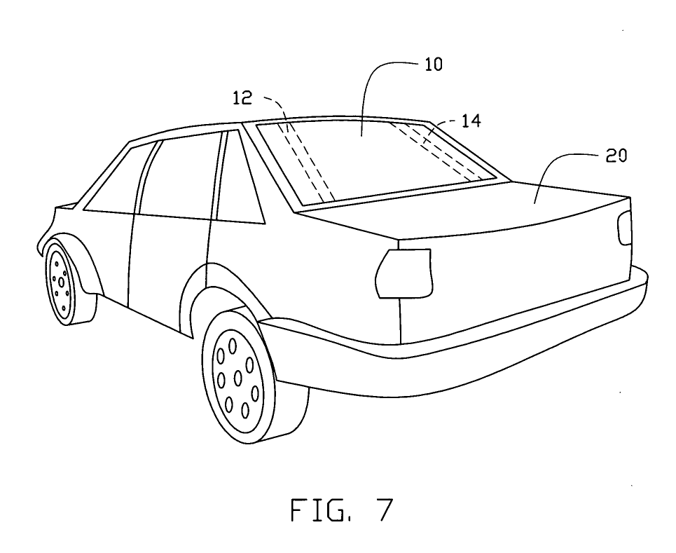

Referring to FIG. 7, one embodiment of a vehicle 20 with a defrost window 10 is provided. The defrost window 10 is used as the back window of the vehicle 20. The carbon nanotube film 15 of the defrost window faces inside the vehicle 20. The first electrode 12 and the second electrode 14 are electrically connected to an electrical source system of the vehicle 20. The defrost window 10 can also be used as the front or side windows of the vehicle 20, because the defrost window 10 is transparent.

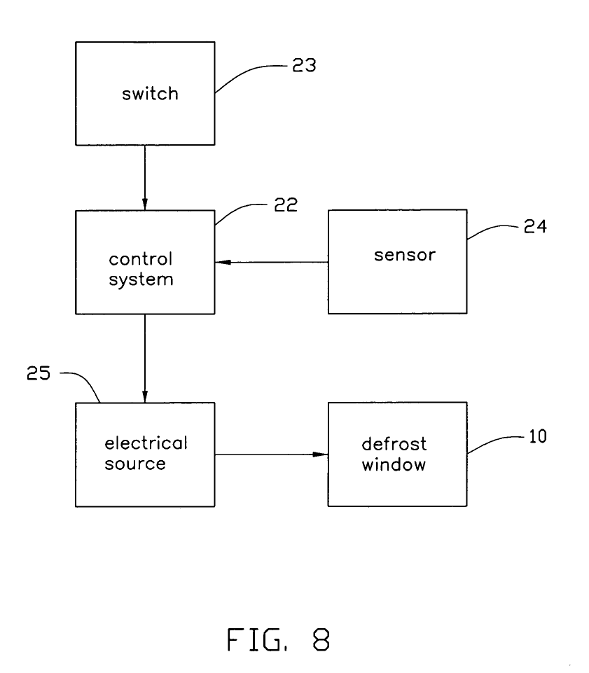

Referring to FIG. 8, in use, the vehicle 20 further includes a control system 22, a switch 23, a sensor 24, and an electrical source 25. The control system 22 is electrically connected to the electrical source 25, to control a voltage of the electrical source 25. The electrical source 25 is electrically connected to the defrost window 10 via the first electrode 12 and the second electrode 14, thus a voltage can be applied on the defrost window 10. The switch 23 is electrically connected to the control system 22 and can be controlled by an operator of the vehicle 20. The sensor 24 is electrically connected with the control system 22, and can detect the frost on the defrost window 10. When there is frost on the surface of the defrost window 10, the sensor 24 will send a signal to the control system 22, whereby the control system 22 will control the defrost window 10 to work.

It is to be understood that the application of the defrost window 10 is not limited to vehicles, and can be used in other applications such as building windows or other surfaces which needs frost reduced.

It is to be understood that the above-described embodiments are intended to illustrate rather than limit the present disclosure. Any elements described in accordance with any embodiments is understood that they can be used in addition or substituted in other embodiments. Embodiments can also be used together. Variations may be made to the embodiments without departing from the spirit of the present disclosure. The above-described embodiments illustrate the scope, but do not restrict the scope of the present disclosure.

What is claimed is:

1. A defrost window, comprising:
a transparent substrate having a top surface;
a carbon nanotube film attached on the top surface of the transparent substrate, the carbon nanotube film having a plurality of carbon nanotubes substantially aligned along a same direction;
a first electrode and a second electrode electrically connected to the carbon nanotube film and spaced from each other, and
a protective layer covering the carbon nanotube film.

2. The defrost window of claim 1, wherein the first electrode and the second electrode are transparent, lamella, and substantially parallel with each other.

3. The defrost window of claim 2, wherein the first electrode and the second electrode are conductive films.

4. The defrost window of claim 3, wherein the conductive film is made of aluminum, copper, tungsten, molybdenum, gold, cesium, or palladium.

5. The defrost window of claim 3, wherein the conductive film is made of indium tin oxide.

6. The defrost window of claim 2, wherein the first electrode and the second electrode are located on a surface of the carbon nanotube film.

7. The defrost window of claim 2, wherein the plurality of carbon nanotubes of the carbon nanotube film is substantially aligned along a direction from the first electrode to the second electrode.

8. The defrost window of claim 7, further comprising a plurality of first electrodes and second electrodes arranged in a staggered manner.

9. The defrost window of claim 8, wherein the plurality of first electrodes is electrically connected together, the plurality of second electrodes is electrically connected together.

10. The defrost window of claim 1, wherein the carbon nanotube film comprises a plurality of successively oriented carbon nanotube segments joined end-to-end by Van der Waals attractive force therebetween.

11. The defrost window of claim 10, wherein the carbon nanotube segment comprises a plurality of carbon nanotubes substantially parallel to each other, and combined by Van der Waals attractive force therebetween.

12. The defrost window of claim 1, further comprising an adhesive layer disposed on the top surface of the transparent substrate, between the transparent substrate and the carbon nanotube film.

13. The defrost window of claim 1, wherein the protective layer is made of made of polycarbonate, polymethyl methacrylate acrylic, polyethylene terephthalate, polyether polysulfones, polyvinyl polychloride, benzocyclobutenes, polyesters, acrylic resins, or epoxy resin.

14. A defrost window, comprising:
a transparent substrate having a top surface;
a plurality of stacked carbon nanotube films disposed on the top surface of the transparent substrate, each carbon nanotube film comprising a plurality of carbon nanotubes combined end to end by Van der Waals attractive force therebetween, and oriented along a same direction;
a protective layer covering the carbon nanotube film.

15. The defrost window of claim 14, wherein each two adjacent carbon nanotube films are combined by Van der Waals attractive force therebetween.

16. The defrost window of claim 14, wherein the first electrode and the second electrode are transparent, lamella, and substantially parallel with each other.

17. The defrost window of claim 16, wherein the carbon nanotubes of at least one of the carbon nanotube films are oriented along a direction from the first electrode to the second electrode.

18. A vehicle, comprising:
at least one defrost window, comprising:
a transparent substrate having a top surface;
a carbon nanotube film attached on the top surface of the transparent substrate, the carbon nanotube film comprising a plurality of carbon nanotubes substantially aligned along a same direction;
a first electrode and a second electrode electrically connected to the carbon nanotube film and spaced from each other; and
a protective layer covering the carbon nanotube film; and
an electrical source electrically connected between the first electrode and the second electrode, to apply electrical current to the carbon nanotube film;
a control system electrically connected to the electrical source and controlling a voltage of the electrical source;
a switch electrically connected to the control system;
a sensor electrically connected to the control system and detecting frost on the defrost window.

19. The vehicle of claim 18, wherein the sensor sends a signal to the control system when it detects frost on the defrost window.

20. The vehicle of claim 18, wherein the plurality of carbon nanotubes of the carbon nanotube film is substantially aligned along a direction from the first electrode to the second electrode.
